(19) United States
(12) Patent Application Publication
(10) Pub. No.: US 2022/0076326 A1
(43) Pub. Date: Mar. 10, 2022

(54) Automated Lot Composition and Pricing System and Method

(71) Applicant: Phoenix Innovations LLC, Alpharetta, GA (US)

(72) Inventors: Amit Anil Mahajan, Cumming, GA (US); Deepak Anand, Pune (IN)

(21) Appl. No.: 17/469,841

(22) Filed: Sep. 8, 2021

Related U.S. Application Data
(60) Provisional application No. 63/076,173, filed on Sep. 9, 2020.

(51) Int. Cl. G06Q 30/08; G06Q 10/08; G06Q 30/02; G06Q 10/06; G06N 3/04

(52) U.S. Cl. CPC G06Q 30/08; G06Q 10/087; G06N 3/0445; G06Q 10/06315; G06N 3/0454; G06Q 30/0206

(57) ABSTRACT

Embodiments are directed to systems and methods for the automation of lot composition and pricing for returned assets sent to auction. Embodiments implement deep learning and optimization techniques to set a starting bid price and create lot composition that will provide an organization with the optimal value for its returned assets. A user portal allows organizations to manage auctions, lots, payment, disputes and other functions for buyers and sellers in the auction marketplace, in addition to viewing data analytics and performing “what if” analysis.

### RELATED APPLICATIONS

This patent application claims the benefit of U.S. Provisional patent application No. 63/076,173, filed Sep. 9, 2020 entitled “AUTOMATED LOT CONFIGURATION AND PRICING SYSTEM AND METHOD” which is incorporated herein by reference in its entirety and for all purposes. A claim of priority is made.

### TECHNICAL FIELD

Embodiments described herein relate generally to a system and method for automatically creating lots and pricing for auctions.

### BACKGROUND

Historically, in the world of electronics supply chain, reverse logistics has been an afterthought. However, easy consumer returns and rapid product upgrade and turnover have elevated the role of reverse logistics in the electronics domain to a process with the potential to unlock the value of used, damaged and otherwise devalued inventory, saving the retailer millions of dollars a year. What is needed is a smart lotting and pricing system that will optimize the return on the disposition of returned items.

### SUMMARY

Worldwide secondary markets exist for electronic devices for both B2B and B2C channels. One such secondary market distribution that has the potential of providing a high revenue stream is the auction. Applicant has developed a novel, AI-driven auction platform that automatically determines optimal lot makeup and pricing that provides an organization with the greatest value for the devices that it has to auction or liquidate.

Embodiments of such an artificial intelligence-driven solution enable reverse logistics operations to determine the highest value disposition for a returned product and to configure lots and set pricing on those items suitable for auction or liquidation for maximum return. The system and method described allows the receiving process to be integrated with the reverse logistics supply chain to automatically create, price and publish lots for auction and communicate the contents of a lot to a warehouse management system for packing and shipping when the lot has been sold.

The platform provides inventory visibility across return facilities with flexibility in lot creation. It also applies pricing analytics such as minimum opening bids/reserve pricing and market-based pricing. It provides channel-based liquidation, including presales, traditional auction, spot buy and auction and salvage paths. The system and method described provides an integrated processing platform from sales order to shipping.

The features, functions and advantages that have been discussed may be achieved independently in various embodiments of the present disclosure or may be combined with yet other embodiments, further details of which can be seen with reference to the following description and drawings.

### BRIEF DESCRIPTION OF THE DRAWINGS

FIG. 1 illustrates an embodiment of a system consistent with this disclosure.

FIG. 2 illustrates an exemplary data analytics system consistent with this disclosure.

FIG. 3 provides an illustration of an exemplary routing and value analysis engine used in reverse logistics to determine which items are available for auction and their characteristics relevant to the auction process.

FIG. 4 illustrates an exemplary process flow for an automated lot creation and pricing revenue maximization engine.

FIG. 5 is a block diagram of a price forecasting system.

FIG. 6 illustrates a block diagram of an exemplary sentiment analysis module for determining the reputation score of an item.

FIG. 7 is a block diagram an automated lot creation module.

FIG. 8 is a flow diagram for automatically creating lots.

FIG. 9 is a screen shot of an exemplary navigation panel for the user portal.

FIG. 10 is a screen shot illustrating weekly targets for auction inventory.

FIG. 11 is a screen shot illustrating recent auction event performance.

FIG. 12 is a screen shot illustrating auction strategy for a financial quarter.

FIG. 13 is a screen shot providing lot management details.

FIG. 14 is a screen shot providing lot traceability details.

FIG. 15 is a screenshot of an exemplary auction scorecard, allowing the user to view performance metrics and results.

FIG. 16 is an illustration of a screen showing a detailed breakdown of auction inventory classified by its status in the auction process.

FIG. 17 illustrates disposition discrepancy metrics table allowing the user to manage discrepancies.

FIG. 18 allows the user to view weekly target forecast analytics that aid the user in determining and setting weekly targets for the auction strategy.

FIG. 19 illustrates a data visualization of Average Sales Price (ASP) for a type of device, broken down by type of price (B2C, B2B, base price and reserve price).

FIG. 20 illustrates sentiment analysis by price and model.

FIG. 21 illustrates a lot management dashboard.

FIG. 22 is a screen shot of a listing of the performance of closed auctions.

FIG. 23 illustrates a dispute resolution system for managing buyer/seller disputes.

FIG. 24 is a diagram depicting an AI/machine learning server and its components.

### DETAILED DESCRIPTION

Embodiments of the claimed subject matter will now be described more fully with reference to the accompanying drawings, in which some, but not all embodiments are shown. The subject matter disclosed may be embodied in many different forms and should not be construed as limited to the embodiments set forth herein; rather, these embodiments are provided so that the disclosure may satisfy legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” It should also be understood that while some embodiments describe the methods or products as comprising one or more elements, the methods or elements may also consist of or consist essentially of the elements disclosed herein.

A “user” as used herein may refer to any entity or individual associated with use of the system or method as described herein. A user may be a seller of products or an employee of such a user, or it may refer to an independent processor providing services for a seller. An operator may refer to an individual receiving and processing an item. A “module” is known to those of skill in the art as computer instructions stored in a server or computer's non-transitory memory, which when executed by a processor direct the specific actions performed by the machine. An “item” refers to a particular piece processed according to this disclosure, while a “product” refers to a class or type of item. The words “item” and “device” may be used interchangeably when discussing an exemplary embodiment.

As used herein, a “user interface” or “user portal” generally includes a plurality of interface devices and/or software that allow a user to input data, manage lots created by the system and view statistics. For example, a user interface may include a graphical user interface (GUI) or an interface to input computer-executable instructions that direct the processing device to carry out specific function. A “system interface” allows two separate systems to meet, interact with and exchange data. Input and output devices may include a display, mouse, keyboard, button, touchpad, touch screen, microphone, speaker, LED, light, joystick, switch, and/or other user input/output device for communicating with one or more users. A number of modules referred to in this disclosure are given the term “engine.” An engine is a part of the system that performs a core or essential function for other programs. Thus, a routing and value analysis engine and the AI based maximization engine perform essential computational functions for this system. In this disclosure, a “secondary market” may be any sales or dispositional opportunity for a returned item.

Unless specifically stated otherwise in context, it may be appreciated that terms such as “processing”, “detecting”, “determining”, “receiving”, or the like may refer to the action and/or processes of a computer or computing system, or similar device that manipulates or transforms data represented as physical quantities within the computing system's registers, memories or other data storage into other data similarly represented within the computing system. The embodiments are not limited in this context.

An automated lot and pricing system and method is described in terms of its use with electronic devices, such as mobile phones, tablets, etc., however, it may be used with any type of item for which secondary markets, such as auction and liquidation markets exist.

An automated lot configuration and pricing system and method provides an integrated auction platform for optimizing the disposition of returned or overstock electronic devices in the auction and refurbished item markets. It acts as a single point of service for a company to manage its auction and liquidation strategy. It automatically creates optimal lots with available devices and includes an auction value forecasting engine that uses multiple algorithms to forecast the selling price of the product in multiple channels and across multiple geographies. The system integrates multiple auction pipelines and provides the oversight over B2B and B2C liquidation processes, with smart listing capabilities to provide the best possible scenarios and routing for the greatest revenue extraction.

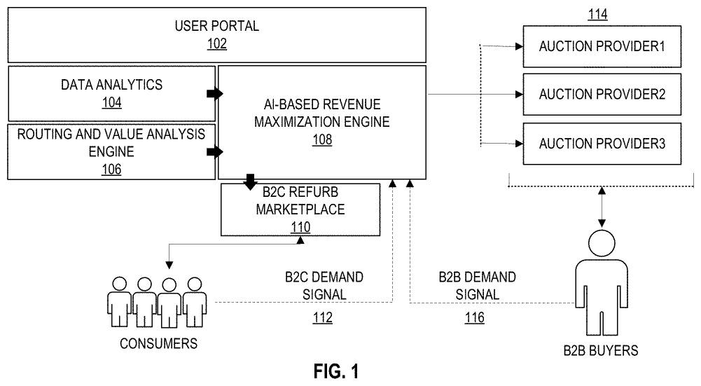

An exemplary embodiment of an automated lot configuration and pricing system is comprised of highly distributed components which provides the middleware orchestration of integration with a company's fulfilment and financial payments systems. FIG. 1 illustrates an exemplary embodiment of an automated lot configuration and pricing system (an AI-based revenue maximization engine) in context. The system allows an organization to optimize and manage its auction and liquidation strategy using multiple artificial intelligence-based algorithms to forecast the selling price of an item in multiple channels in multiple geographies. It provides smart lotting capabilities for maximizing the value of bulk item sales, and a base reserve price, from which may be added or subtracted a premium or discount based on the popularity of an item. Additionally, the system may be integrated with an organization's fulfilment and financial payment systems so the user may observe their auction status, payment notifications, shipment status, shipment notifications and unlock codes. It may provide a payment gateway integration into the organization's accounts payable system for automated planning and payments.

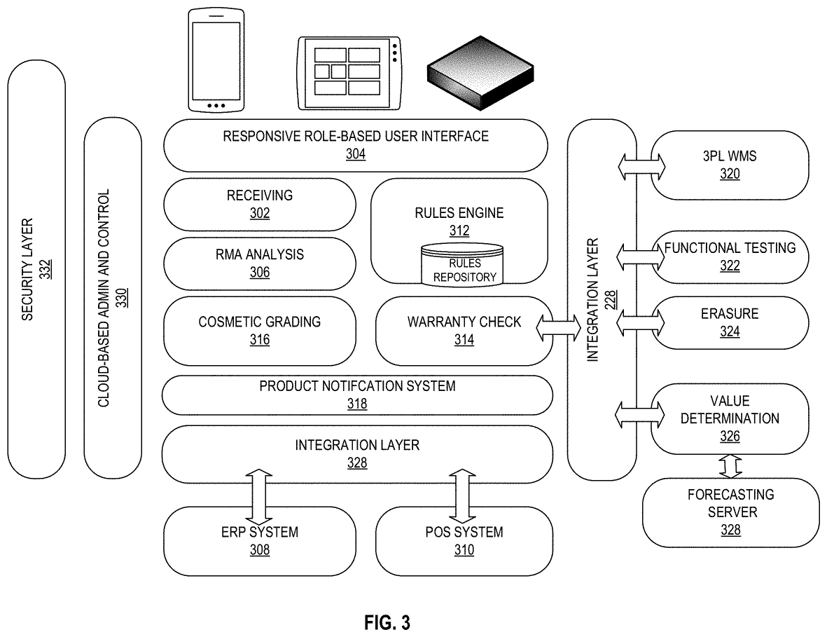

Referring to FIG. 1, a user entry portal, or user interface 102 sits on top of a data analytics (business analytics) system 104 and a reverse-logistics routing and value analysis engine 106 which determines the potential value of each item in the reverse flow. The data analytics system 104 may incorporate data from throughout an organization that is applicable to the disposition of the returned assets. Data also includes external data resources 112, 116 that may feed deep learning algorithms to create channel forecasts and optimized pricing and lot configurations. A reverse-logistics routing and value analysis engine 106 processes returned items on the warehouse floor to determine what kind of disposition may be appropriate for the item in terms of the business rules used by the company and determines its maximal value under those rules. This type of system may be a computer-based routing system, for example, with components like those illustrated in FIG. 3 that may use item identifiers and sales/returns transactions to determine how and when the item was first sold, when it was returned, whether it is under warranty, and what the item's cosmetic and functional condition is in order to determine how the most value may be extracted from each individual item. These systems feed data into the AI-based revenue maximization engine 108, the output of which is provided to both B2C and B2B sales channels 110, 114 accessible by buyers of a device. Lots are published to auction providers 114 and may be managed and tracked using the user interface 102. The use of a routing and value analysis engine 106 to determine devices available for auction is a complex process which helps to maximize the value of returned items by finding the optimal disposition of an item, which can include, but is not limited to auction. Such a complex process provides the best possible return for the organization, but all components are not required in order to feed devices into the automated lot and pricing system; fewer or other components may be used. In some embodiments a minimal device profile (make, model, memory, cosmetic grade, functional status) is required.

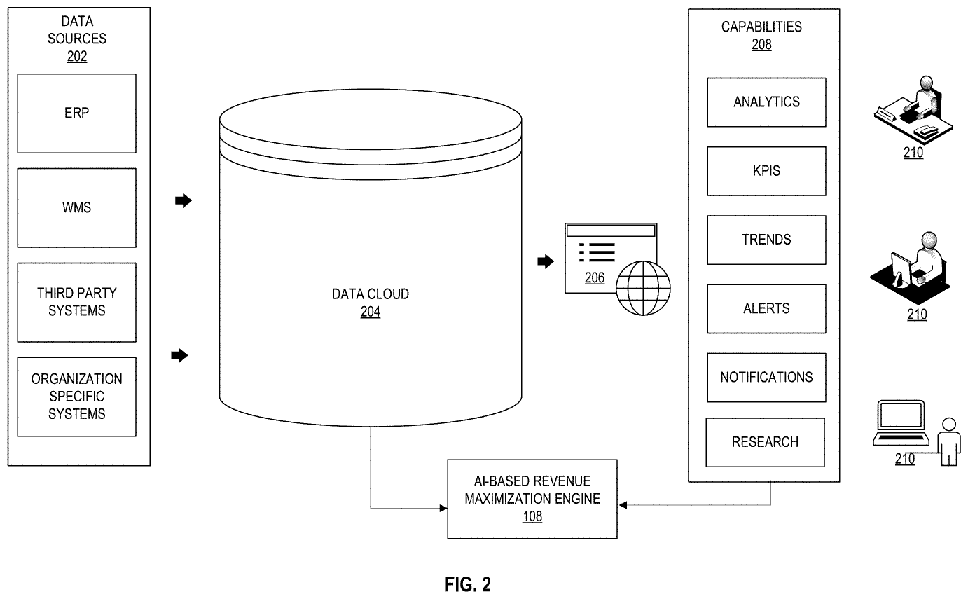

FIG. 2 illustrates an exemplary data analytics system 104 consistent with this disclosure. Such a system extracts data from data sources 202 throughout an organization, such as an enterprise resource planning system (ERP), warehouse management system (WMS), third party systems, and organization specific systems, such as departmental databases, in order to provide input for business strategy and tracking. As is known by those of ordinary skill in the art, these data sources are computing systems with processing, communication, and memory capabilities. They may receive, process, store and transmit data to other systems via system interface communications. Data received may be processed and stored in a data cloud 204 for web (intranet/internet) access 206. Capabilities 208 for such a system include calculation and direct presentation of analytics, KPIs, trends, and provision of alerts and notifications to users and research capabilities but may also be extracted or transferred to the revenue maximization engine 108 for further processing in accordance with its own capabilities. This data may be used for planning and auction and liquidation strategy development as the user 210 interacts with the user portal 102 (discussed further below) as well as used in training and processing the AI-based algorithms provided by the maximization engine 108.

FIG. 3 illustrates an exemplary routing and value analysis engine 106 consistent with this disclosure. In some embodiments, the system may be a complex, highly distributed and highly integrated embodiment of the disclosed subject matter, comprising memory, processor and computer executable instructions stored in memory which, when executed by the processor, cause the system to perform the functions described by each module. Modules are described below at a high level.

Items returned by purchasers may be received at a warehouse, retail store, through a kiosk or similar receiving station 302. The receiving process may be broken down in various steps 302 with the sub-stations manned with operators each of whom process the items with a single service. Alternatively, a receiving station 302 may be available which performs a substantial number of services in place, with items conveyed when required. Items may be conveyed along receiving sub-stations 302 for performance of services. Each item receiving station 302 may be equipped with a terminal or computing device with access to a network. Operators may access a role-based user interface 304 allowing performance of different receiving functions according to function, and view dashboards related to management of the system.

An RMA analysis module 306 allows a user to access records related to a return, such as the RMA against which the item will be received and details regarding the transaction. The user may also conduct research on the item or an RMA. Generally, RMA information may be extracted by API or other data communication method, from an integration with a WMS, ERP 308, POS 310 or kiosk system in which the transaction was initiated. The item's entire history may be extracted and viewed when an item is serialized or is otherwise identifiable in the system.

Rules logic 312 and repository provide rules and data that drive the gateway (i.e. a dispositional path based on business rules or needs) or further disposition of an item. Rules may be based on the business and operational requirements of a reverse logistics organization. In an embodiment, an organization may have a plurality of sales channels running a plurality of programs with rules under which a product may be sold and returned. The product itself may have restrictions, for example, a model that is obsolete or is no longer in demand may take a different dispositional path than a current model. Similarly, an individual item may have rules attached to it based on various attributes. Rules may be complex and have one or more dependencies that determine an item disposition. A rule logic module 312 with memory and processor may apply rules at multiple layers of business and operational levels, for example the channel, program, product, item and transactional data levels. An item profile stored in a system database may be evaluated for applicable rules at any time during the process.

A warranty module 314 provides disposition according to original equipment manufacturers (OEM) or secondary rebuild or redistribution vendor warranties and/or supplier's policies. Rule logic and eligibility requirements may direct an item to the warranty module 314 for processing. Rules regarding warranty disposition may be complex; an item eligible for warranty may not be directed back to the warrantor if other rules take precedence. An exemplary warranty process is described in the exemplary embodiment below.

An inspection and cosmetic grading 316 sub-system may determine the physical/cosmetic state of an item and contribute to the item value determination for a secondary market. For example, cloth rips and tears, broken zippers, stains and missing notions on an item of apparel, or scratches and dents on a television screen greatly reduce the options for high value disposition. In addition to value determination, these attributes determine what kind of secondary processing may be required in order for the item to be resold in a particular secondary market. Cosmetic grading typically requires a machine with computer vision capabilities in order to determine a cosmetic rating for a device, which has an effect on the price at which a particular item may be disposed.

A product notification 318 system may be utilized for communications regarding the receiving process. As items are dispositioned, a label is printed and attached to the product and the product is directed to the appropriate intermediate or endpoint disposition bin or bucket.

As was described above, the system may be integrated with an enterprise resource planning system (ERP) 308 and/or a point of sale (POS) 310 or kiosk system which initiate sales and return transactions or are otherwise interfaced with the intelligent disposition system. In addition, the system may be integrated with a warehouse management system (WMS) 320, which may be both the source of data and the target of updates when the item receiving process is complete.

A specialty services module 322 comprises computer-executable instructions stored in memory, which, when executed by the processor directs the computer to perform any special services required for an item in order to determine its optimal dispositional value. Special services are generally product dependent and may generally be used to test the functional operation of the item or perform a service required for a particular product. As the items move through special services, results of each service are added to the item profile.

Finally, item profiles are processed through a value determination 324 module which determines the optimal disposition for the item. As the optimal disposition is determined, a label may be printed or marked with infrared ink, with item details and a physical location for disposition (for example, a number or location of a shipping tote for salvaged items) and affixed to the item. The item may then be physically conveyed to the appropriate location. The value determination module 324 may be operatively connected to a forecasting server 326 for determining the optimal value disposition of an item. Those items that are determined to have an optimal disposition of resale or auction, or similar disposition, may have their profile transmitted to the AI-based revenue maximization engine 108 where they may be apportioned to consumer resale, B2B resale/auction, and be priced, lotted, and placed in an auction for final disposition.

It will be apparent to those of ordinary skill that FIGS. 2 and 3 are merely examples of the type of source systems that could feed data into the revenue maximization engine, and that other systems providing the required data profile may be used for the same purpose. These illustrations of exemplary systems in no way limit the input that may be used by the revenue maximization engine.

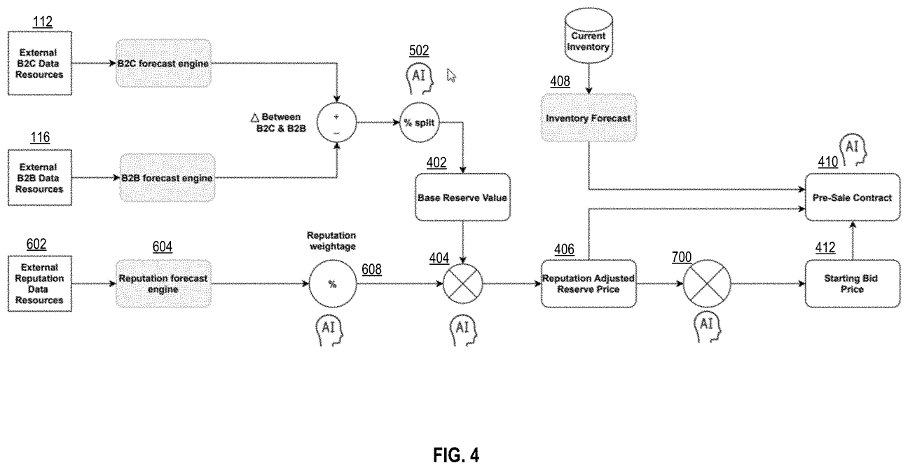

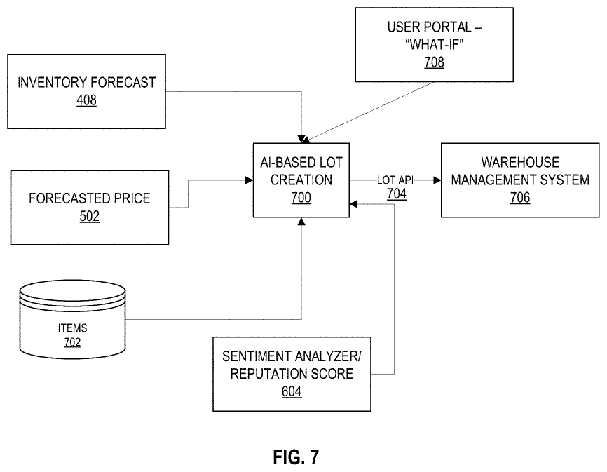

FIG. 4 illustrates an exemplary process flow for a revenue maximization engine and creating forecasted pricing for pre-sale agreements on expected inventory as well as creating and pricing lots from available inventory. A variety of data sources are used for this purpose. External consumer 112 and B2B 116 data resources provide demand related data in order to create a pricing forecast for each channel over the planning horizon. These channels are forecasted separately to account for different factors that go into pricing the different channels. The deep learning algorithm 402 determines the margin and provides an indication of maximum value to be obtained by splitting the available margin among the two channels, and a base reserve value. External reputation data resources 602 (see FIG. 6) are used by a reputation forecast engine 604 (sentiment analyzer) to calculate a reputational weight or score 608, which may result in a premium or discount being applied to the base reserve value 404 to calculate a reputation-adjusted reserve price 406 which may be applied as a starting bid price 412 to a lot automatically created by a lot creation module 700 (see FIG. 7). An inventory forecast 408 model determines the items that are available for auction or liquidation over the planning horizon. Inventory forecasts allow the auction manager to create pre-sale agreements 410 at forecasted prices with auction buyers. Lots created 700 out of available inventory are given a starting bid price 412 depending on the composition of the lot and historical data and are published to an auction site 410.

Artificial intelligence methods, deep learning methods in particular, being highly scalable, accurate and adaptive to fluctuating behavior, provide superior results compared to programmatic/statistical methods of forecasting. The maximization engine 108 may use deep learning methods, such as recurrent neural networks, long short-term memory networks, gated recurrent unit networks and attention mechanisms (time series forecasting with machine learning), training the models on historical data to develop models for forecasting consumer and business demand, and for performing a sentiment analysis to determine a reputation score. The deep learning algorithms described here are mentioned by way of example and not limitation, and other appropriate algorithms may be used in their place.

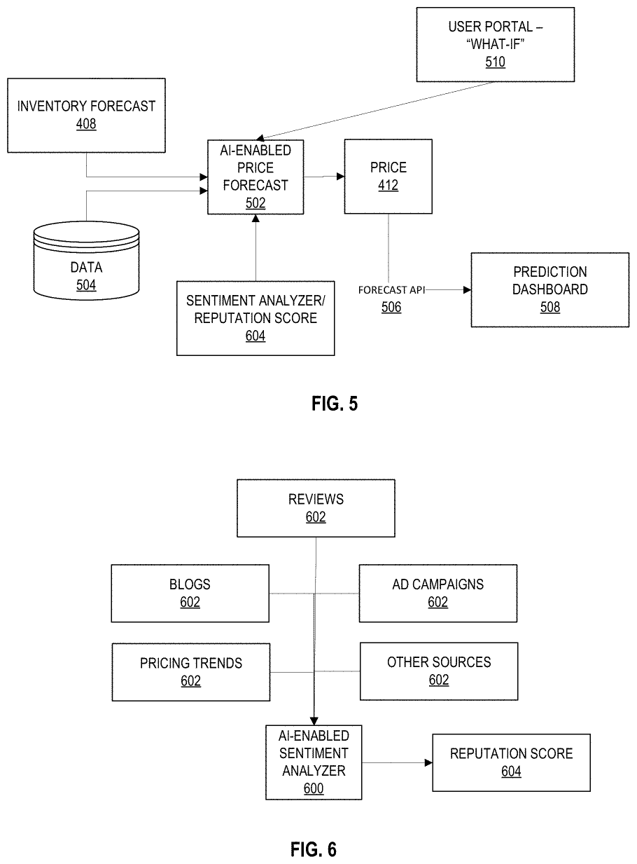

In an exemplary embodiment, a revenue maximization engine 108 may use a number of machine learning or deep learning models, either alone or in combination, for forecasting inventory and price, performing sentiment analysis and lotting. Time series forecasting with deep learning algorithms may be used for determining inventory, which may be determined for sales as a whole or by sales channel. Time series algorithms typically are comprised of factors such as long-term trends, seasonality, stationarity (changes over time), noise such as random fluctuations or variations due to uncontrolled factors, and autocorrelation. An inventory forecast module 408 may train a time-series forecasting block using historically observed data, while taking into account significant events, launch of new items, holiday offers, etc. Referring to FIG. 5, price forecasting 502 is another AI module that may take advantage of an attention-based time series forecasting block. Channel-based price forecasting may be based on grouping techniques of like items, in particular, domain specific features of like items obtained from an item data store 504. Prices 412 may be derived from parent group pricing using a relative weight for relevance of each item. Users may perform a “what-if” analysis 510 by applying alternative pricing strategies, which is then viewable in the user portal via a pricing forecast API 506 to a prediction dashboard 508.

The sentiment analyzer, or market-trend analyzer module 600, the components of which are illustrated in FIG. 6, takes data from external unstructured data 602 like news, offers, launch, advertisement campaign, reviews, trending hashtags, and anonymized features from the observed pricing trend in competitive auctions for training. This module may be a multi-modal deep learning model which gives a normalized reputation score for a brand based on the above-mentioned data. The reputation score 604 may be used to apply a premium or discount to the price of an item that reflects its desirability in the marketplace, as is depicted in FIG. 5 604.

Finally, an exemplary AI-based lot generation module 700 may use classical optimization techniques which optimizes unit quantity, profit margin and types of items in a lot. This module uses a metric based on the historical data from inventory, and auctions statistics for assessing that a generated lot is how likely to be sold. As is illustrated in FIG. 7, the lot creation module may use pricing 502 forecasts, item information 702, and the reputation score 604 to determine an optimal combination of individual items for a lot that will maximize value for the items involved. Lots may be created in any desired size with any combination of items, however, the system is most useful when its AI module is allowed to automatically create the lots, as the optimization algorithm applied in this module determines the maximum value combinations of all available products. A Lot Creation Application Programming Interface (API) 704 communicates the lot configurations and contents to the warehouse management system 706 to pack and ship the lot once it has been sold. This module has a “what-if” feature 708, that allows a user to view alternative scenarios for lotting.

FIG. 8 illustrates the method steps for automated lot configuration. To begin with, the profile data on available items is captured from the reverse logistics routing and value analysis engine 802. As was discussed above, these are the items that have been determined to be appropriate for auction or liquidation. Forecast price is determined for the items available for lotting and a reputation score is calculated for each item and applied to the item price to determine the reputation adjusted reserve price 804. The parameters for an optimized lot are determined based on 806 available items, quality of item and marketplace preferences. Lots are created by optimizing the configuration of the lot 808. Lots may be pure or mixed. Historical bid data provides marketplace preference data. Referring again to FIG. 7, the created lot composition is communicated to the warehouse via an API 704 and the lot is posted for sale on selected auction sites 114. There are many established auction markets and marketplaces for mobile electronics. The auction sites may be selected by a user or may be automatically determined by checking available auctions in strategic geographical locations. While pre-sales use forecasted inventory and therefore the items in the lot must be added when the lot is built, lots created from available inventory may be specific to the serial number of the item, as they different models of the same item may be of different quality.

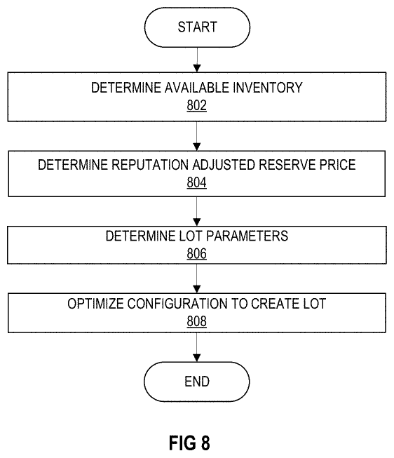

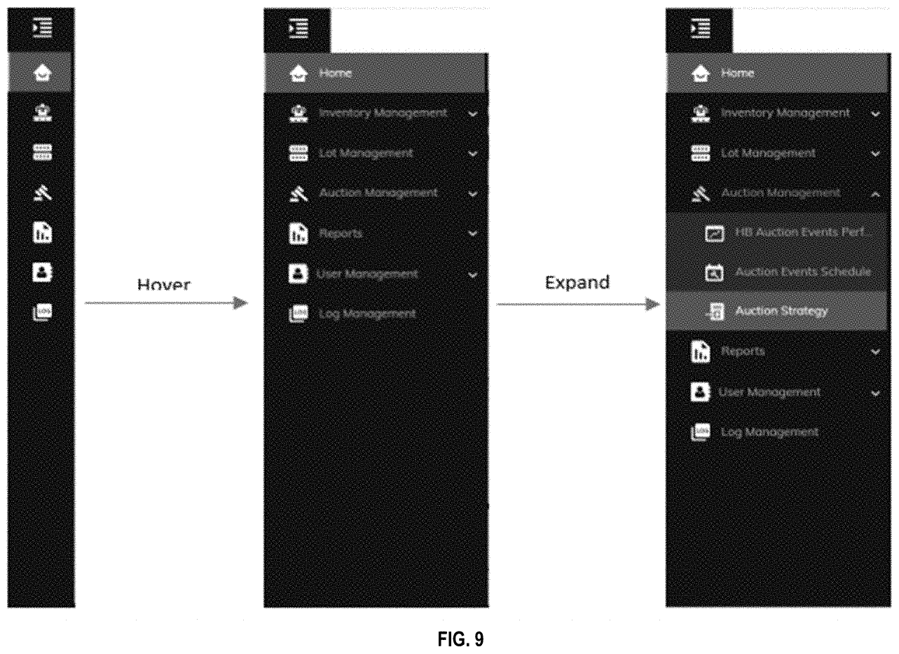

A user portal or interface may be provided for inventory, operations, reverse logistics and other personnel to manage and view the auction and liquidation processes from an item's entry into the system through receipt of payment for an auctioned lot. An exemplary user portal 102 is illustrated with the screen shots in FIGS. 9-23. The user portal provides access to the underlying applications and allows users to interact from both the seller and buyer perspectives in auction markets 114 and consumer marketplaces 110 and perform additional functions related to the disposition of items, including settling disputes between buyers and sellers (as will be described in more detail below) shipping and completing/receiving payments and accounting.

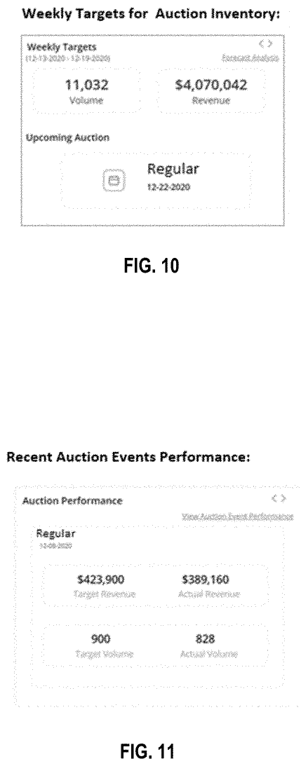

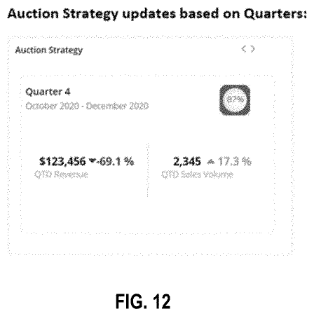

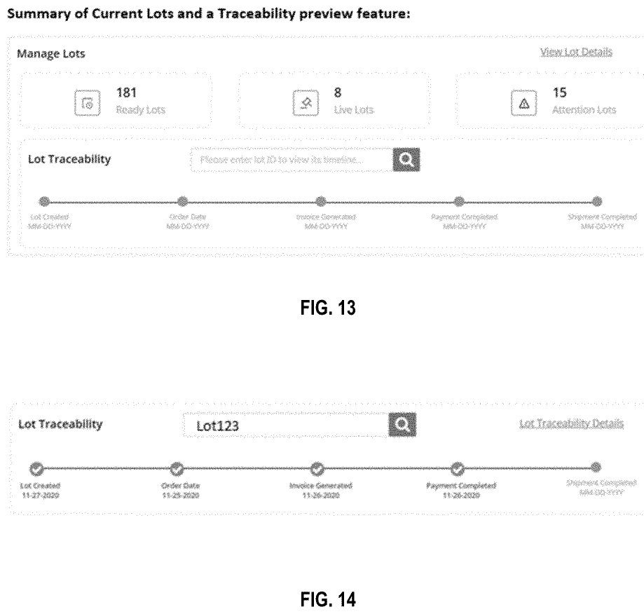

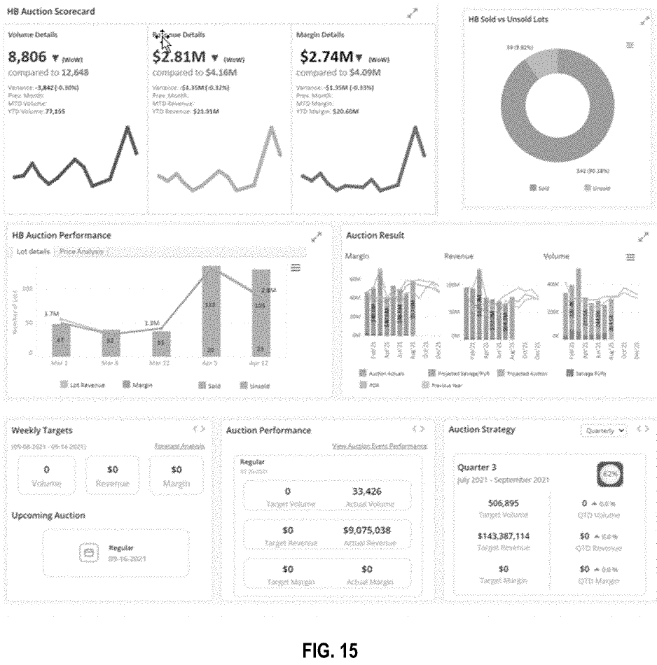

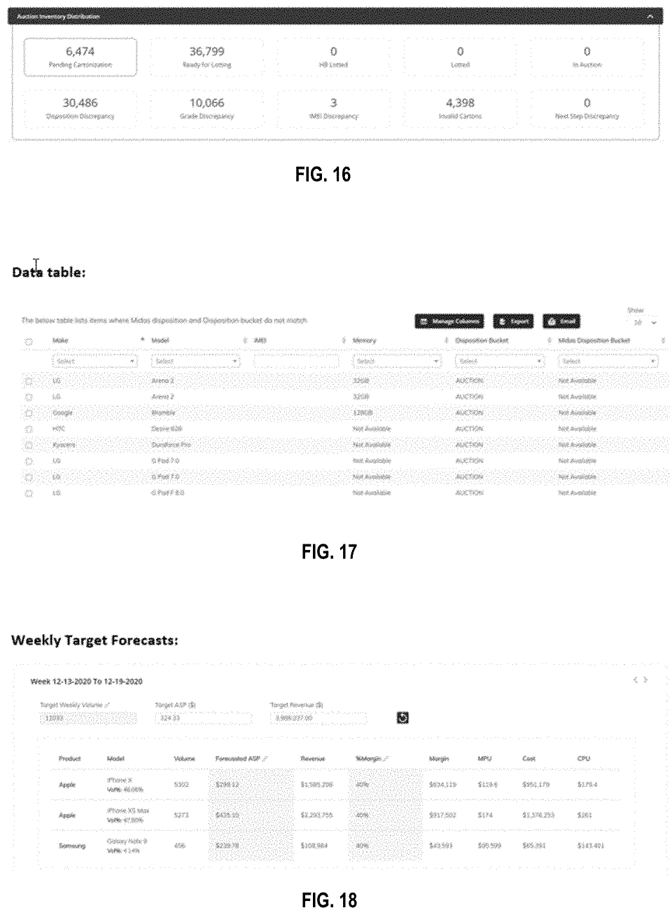

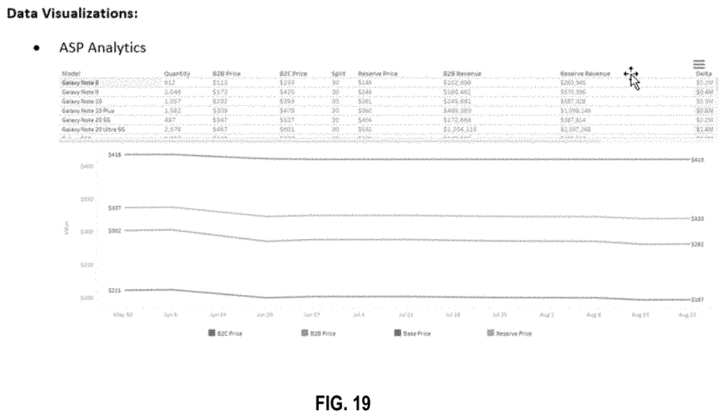

FIG. 9 is a screen shot of an exemplary navigation panel for the user portal 102. The portal functions may be organized according to user role. Some roles include buyer, inventory analyst, operations manager, and others, however, the screen shots included here are related to auction analysis and management, lot creation and management and analytics that provide the user with a view to how well the automated system is performing. An auction analyst may decide auction targets, schedule auction events and analyze past auctions. FIGS. 10 and 11 illustrate auction targets and performance screens that allow an auction analyst or similar role to track volume and revenue targets (FIG. 10). FIG. 11 is a screen that allows the analyst to review key performance indicators (KPIs) for a particular auction event and may view additional details of the event performance. FIG. 12 provides auction strategy by quarter. FIGS. 13 and 14 provide lot management and traceability details. FIG. 15 is a screenshot of an exemplary Auction Scorecard, allowing the user to view performance metrics and results. FIG. 16 is an illustration of a screen showing a detailed breakdown of auction inventory classified by its status in the auction process. This screen allows the user to drill down to obtain the details behind each of the metrics presented. For example, clicking on the Disposition Discrepancy metric presents the data table of FIG. 17, allowing the user to manage discrepancies. FIG. 18 allows the user to view weekly target forecast analytics that aid the user in determining and setting weekly targets for the auction strategy. FIG. 19 illustrates a data visualization of Average Sales Price (ASP) for a type of device, broken down by type of price (B2C, B2B, base price and reserve price).

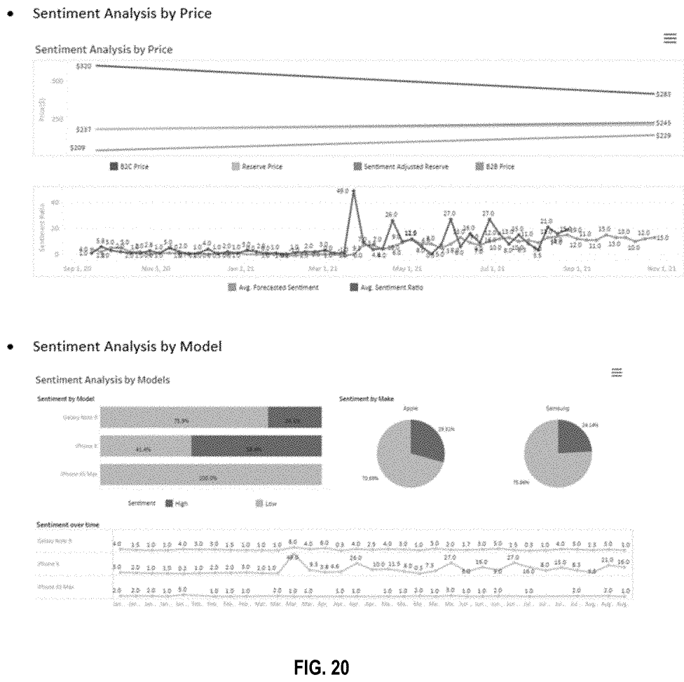

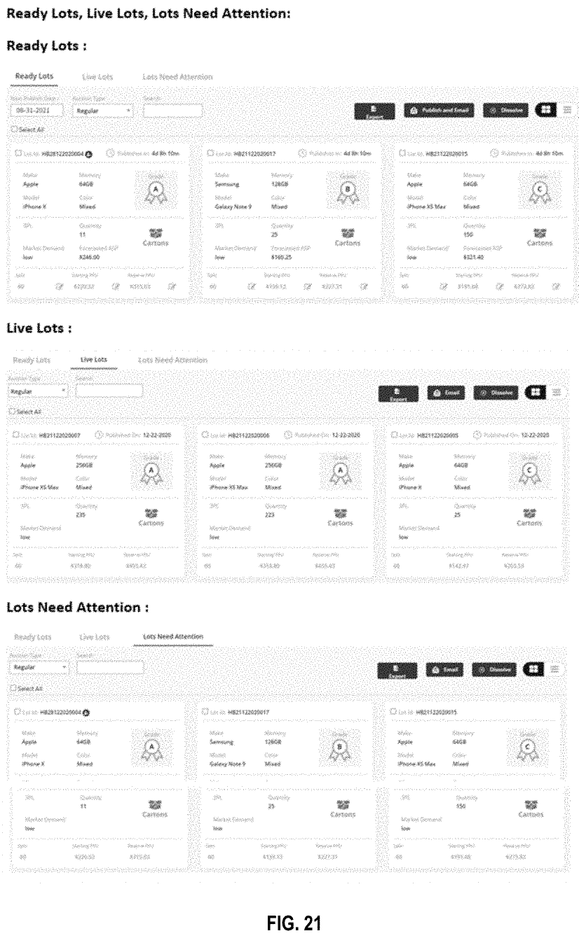

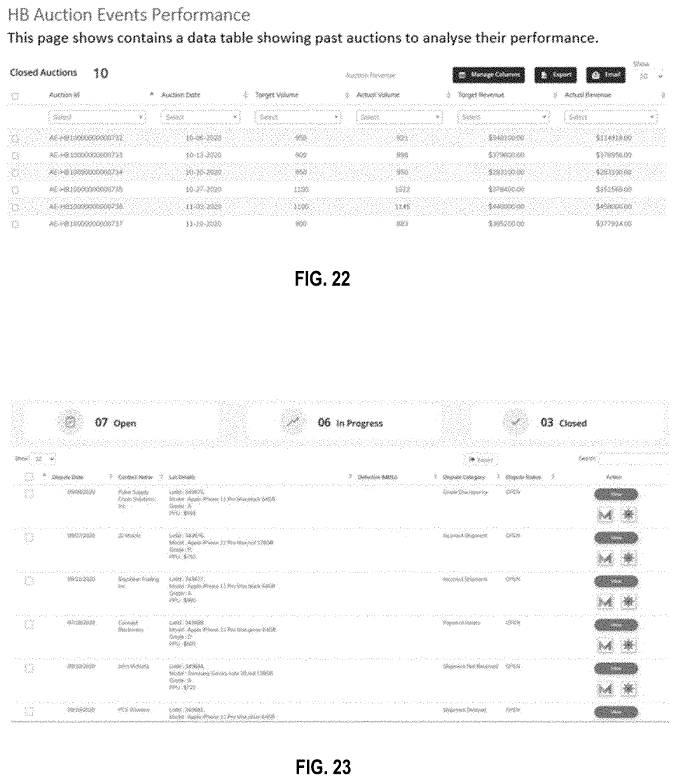

FIG. 20 illustrates sentiment analysis by price and model. The user may determine how well the sentiment analysis performs by comparing the final price paid to the reputation-weighted price. FIG. 21 aids the user in managing lots by presenting a lot dashboard, showing ready lots (pending auction), live lots (in auction) and lots that need attention. FIG. 22 is a screen shot of a listing of the performance of closed auctions. FIG. 23 illustrates a dispute resolution system for managing buyer/seller disputes. The system provides a customer complaint interface which routes complains to a seller's dispute resolution team, who determine whether technical support or a replacement or refund is in order.

The system and method disclosed herein comprises a computing device and various hardware components and subsystems. A computing device may also be referred to as a computer or server. Software applications or modules, comprised of computer-executable instructions stored in computer-usable or computer-readable, non-transitory memory or non-transitory secondary storage for execution by a processor are operatively configured to perform the operations as described in the various embodiments. Any suitable computer-usable or computer-readable medium may be utilized. For example, and not limitation, the computer-usable or computer-readable medium may be an electronic, magnetic, optical, electromagnetic, infrared or semiconductor system, apparatus or device. The software applications may correspond with a single module or any number of modules. Modules of a computer system may be made from hardware, software, or a combination of the two. Generally, software modules are program code or instructions for controlling a computer processor to perform a particular method to implement the features or operations of the system. The modules may also be implemented using program products or a combination of software and specialized hardware components. In addition, the modules may be executed on multiple processors for processing a large number of transactions, if necessary or desired.

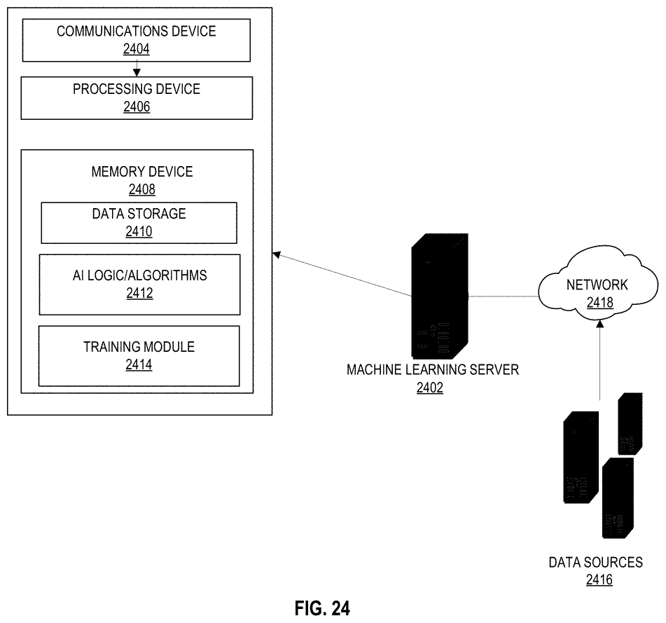

AI-based modules may be implemented from machine learning servers 2402, such as that illustrated in FIG. 24. These servers are comprised of a communications device 2404, a processing device 2406 and a memory device 2408. The memory device may include, at a minimum, data storage 2410, AI or deep learning algorithm/logic 2412 and, a training module 2414 that may perform both unsupervised and supervised training, depending on the problems and goals being evaluated.

Although the computer, computing device or server has been described with various components, it should be noted that such a computer, computing device or server can contain additional or different components and configurations. In addition, although aspects of an implementation consistent with the system disclosed are described as being stored in memory, these aspects can also be stored on or read from other types of computer program products or computer-readable media, such as secondary storage devices, a non-transitory carrier wave from the Internet or other network; or other forms of RAM or ROM. Furthermore, it should be recognized that computational resources can be distributed, and computing devices can be client or server computers. Client computers and devices (e.g.) are those used by end users to access information from a server over a network, such as the Internet or a local area network. These devices can be a desktop or laptop computer, a standalone desktop, or any other type of computing device. Servers are understood to be those computing devices that provide services to other machines, and can be (but are not required to be) dedicated to hosting applications or content to be accessed by any number of client computers. Operations may be performed from a single computing device or distributed across geographically or logically diverse locations.

Communications between subsystems may be driven by computing device executable code by some type of interface, such as ethernet, Bluetooth, USB, or other connection. Remote access by customers or users may be provided by web services or networks. A computing device may transmit network-based services requests to external systems networks via external networks. In various embodiments, external networks may encompass any suitable combination of networking hardware and protocols necessary to establish network-based communications between clients and service provider network. For example, a network may generally comprise various telecommunications networks and service providers that collectively implement the Internet. A network may also include private networks such as local area networks (LANs) or wide area networks (WANs) as well as public or private wireless networks. For example, both a given client and service provider network may be provisioned within enterprises having their own internal networks. In such an embodiment, a network may include the hardware (e.g., modems, routers, switches, load balancers, proxy servers, etc.) and software (e.g., protocol stacks, accounting software, firewall/security software, etc.) necessary to establish a link between a client and the Internet as well as between the Internet and a service provider network. It is noted that in some embodiments, clients may communicate with server provider network using a private network rather than the public Internet.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A system, comprising:
a routing and value analysis engine comprising at least a processor, a memory, and computer-executable instructions stored in memory which when executed by the processor cause the processor to:
determine items suitable for auction;
create an item profile;
an AI-based revenue maximization engine comprising at least a processor, a memory, computer-executable instructions stored in memory which when executed by the processor cause the processor to:
receive inventory data and item profile of items available for auction;
determine the optimal lot configuration for the available items;
determine the optimal auction base reserve price for the lot;
publish the lot to auction providers.

2. The system of claim 1 where the AI-based revenue maximization engine further comprises a reputation analysis module for determining a weighting factor to apply to the base price depending on the popularity of the items in the lot.

3. The system of claim 1 wherein the deep learning models used for forecasting are of the type recurrent neural networks, long short-term memory networks, gated recurrent unit networks and attention mechanisms for time series forecasting.

4. The system of claim 1 wherein the AI-based models for lot generation are based on classical optimization techniques optimizing unit quantity, profit margin and types of items in a lot.

5. The system of claim 1 wherein the AI-based revenue maximization engine trains deep learning models with historical data from the data analysis system, the routing and value analysis engine and auction statistics.

6. The system of claim 2 wherein the data received comprises data related to auctions in various markets including global markets.

7. The system of claim 1 further comprising an integration with enterprise resource planning modules to complete financial transactions.

8. A method for creating optimal lot configuration and pricing, the method implemented by one or more processors and comprising:
receiving and storing item data:
determining available inventory;
determining the reputation adjusted reserve price;
determining lot parameters; and
optimizing configuration to create the lot.

9. The method for creating optimal lot configuration and pricing of claim 8 where with the additional steps of:
Publishing the lot on auction sites; and
Communicating the composition of the lot to the warehouse for packing and shipping.
